(19) United States
(12) Patent Application Publication
(10) Pub. No.: US 2023/0350171 A1
(43) Pub. Date: Nov. 2, 2023

(54) IMAGING LENS SYSTEM AND CAMERA

(71) Applicant: Panasonic Intellectual Property Management Co., Ltd., Osaka (JP)

(72) Inventor: Kenichi EMI, Osaka (JP)

(21) Appl. No.: 18/138,934

(22) Filed: Apr. 25, 2023

(30) Foreign Application Priority Data
Apr. 28, 2022 (JP) 2022-074036

(51) Int. Cl. G02B 15/14; H04N 23/55; G02B 13/00

(52) U.S. Cl. CPC G02B 15/1425; H04N 23/55; G02B 13/0045

(57) ABSTRACT

An imaging lens system consists of: a first lens group; an aperture stop; and a second lens group having positive power. The first lens group includes: a first lens having negative power; a second lens having negative power; and a sub-lens group having positive power. The first lens is a negative meniscus lens having a surface convex toward an object. The second lens is a negative meniscus lens having a surface convex toward the object. The imaging lens system satisfies the following inequalities (1) and (2):

0.35<T2/R2<4.0 (1)

3.0<T4/R4<10.0 (2).

### CROSS-REFERENCE TO RELATED APPLICATIONS

The present application is based upon, and claims the benefit of priority to, Japanese Patent Application No. 2022-074036, filed on Apr. 28, 2022, the entire contents of which are hereby incorporated by reference.

### TECHNICAL FIELD

The present disclosure relates to an imaging lens system and a camera. More particularly, the present disclosure relates to an imaging lens system including a first lens group and a second lens group and a camera including the imaging lens system.

### BACKGROUND ART

JP 2018-55045 A discloses a wide-angle lens system which uses a relatively small number of lenses (e.g., six) in total and in which the respective shapes, arrangement, and other parameters of those lenses are optimized.

### SUMMARY

The present disclosure provides an imaging lens system with the ability to downsize the optical system and improve the manufacturing efficiency of lenses and also provides a camera including such an imaging lens system.

An imaging lens system according to an aspect of the present disclosure consists of: a first lens group; an aperture stop; and a second lens group having positive power. The first lens group, the aperture stop, and the second lens group are arranged in this order such that the first lens group is located closer to an object than the aperture stop or the second lens group is and that the second lens group is located closer to an image than the first lens group or the aperture stop is. The first lens group includes: a first lens having negative power; a second lens having negative power; and a sub-lens group having positive power. The first lens, the second lens, and the sub-lens group are arranged in this order such that the first lens is located closer to the object than the second lens or the sub-lens group is and that the sub-lens group is located closer to the image than the first lens or the second lens is. The first lens is a negative meniscus lens having a surface convex toward the object. The second lens is a negative meniscus lens having a surface convex toward the object.

The imaging lens system satisfies the following inequalities (1) and (2):

0.35<T2/R2<4.0 (1)

3.0<T4/R4<10.0 (2)

where R2 is a radius of curvature of an image-side surface of the first lens, R4 is a radius of curvature of an image-side surface of the second lens, T2 is a distance on an optical axis between the image-side surface of the first lens and an object-side surface of the second lens, and T4 is a distance on the optical axis between the image-side surface of the second lens and an object-side surface of a lens belonging to the sub-lens group and located closer to the object than any other lens belonging to the sub-lens group.

A camera according to another aspect of the present disclosure includes an imaging lens system and an image sensor that transforms an optical image formed by the imaging lens system into an electrical image signal. The imaging lens system consists of: a first lens group; an aperture stop; and a second lens group having positive power. The first lens group, the aperture stop, and the second lens group are arranged in this order such that the first lens group is located closer to an object than the aperture stop or the second lens group is and that the second lens group is located closer to an image than the first lens group or the aperture stop is. The first lens group includes: a first lens having negative power; a second lens having negative power; and a sub-lens group having positive power. The first lens, the second lens, and the sub-lens group are arranged in this order such that the first lens is located closer to the object than the second lens or the sub-lens group is and that the sub-lens group is located closer to the image than the first lens or the second lens is. The first lens is a negative meniscus lens having a surface convex toward the object. The second lens is a negative meniscus lens having a surface convex toward the object.

The imaging lens system satisfies the following inequalities (1) and (2):

0.35<T2/R2<4.0 (1)

3.0<T4/R4<10.0 (2)

where R2 is a radius of curvature of an image-side surface of the first lens, R4 is a radius of curvature of an image-side surface of the second lens, T2 is a distance on an optical axis between the image-side surface of the first lens and an object-side surface of the second lens, and T4 is a distance on the optical axis between the image-side surface of the second lens and an object-side surface of a lens belonging to the sub-lens group and located closer to the object than any other lens belonging to the sub-lens group.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 illustrates lens arrangements showing an infinity in-focus state of an imaging lens system according to a first embodiment (corresponding to a first example of numerical values);

FIG. 2 illustrates longitudinal aberration diagrams showing what state the imaging lens system in the infinity in-focus state assumes in the first example of numerical values;

FIG. 3 is a graph showing the resolution per unit angle of view of the imaging lens system in the first example of numerical values;

FIG. 4 illustrates lens arrangements showing an infinity in-focus state of an imaging lens system according to a second embodiment (corresponding to a second example of numerical values);

FIG. 5 illustrates longitudinal aberration diagrams showing what state the imaging lens system in the infinity in-focus state assumes in the second example of numerical values;

FIG. 6 is a graph showing the resolution per unit angle of view of the imaging lens system in the second example of numerical values;

FIG. 7 illustrates lens arrangements showing an infinity in-focus state of an imaging lens system according to a third embodiment (corresponding to a third example of numerical values);

FIG. 8 illustrates longitudinal aberration diagrams showing what state the imaging lens system in the infinity in-focus state assumes in the third example of numerical values;

FIG. 9 is a graph showing the resolution per unit angle of view of the imaging lens system in the third example of numerical values;

FIG. 10 illustrates lens arrangements showing an infinity in-focus state of an imaging lens system according to a fourth embodiment (corresponding to a fourth example of numerical values);

FIG. 11 illustrates longitudinal aberration diagrams showing what state the imaging lens system in the infinity in-focus state assumes in the fourth example of numerical values;

FIG. 12 is a graph showing the resolution per unit angle of view of the imaging lens system in the fourth example of numerical values;

FIG. 13 illustrates lens arrangements showing an infinity in-focus state of an imaging lens system according to a fifth embodiment (corresponding to a fifth example of numerical values);

FIG. 14 illustrates longitudinal aberration diagrams showing what state the imaging lens system in the infinity in-focus state assumes in the fifth example of numerical values;

FIG. 15 is a graph showing the resolution per unit angle of view of the imaging lens system in the fifth example of numerical values; and

FIG. 16 is a schematic representation of an onboard camera including the imaging lens system according to the first embodiment.

### DETAILED DESCRIPTION

Embodiments of the present disclosure will now be described in detail with reference to the accompanying drawings as appropriate. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided by the applicant to help one of ordinary skill in the art understand the present disclosure fully and should not be construed as limiting the scope of the present disclosure, which is defined by the appended claims.

### First to Fifth Embodiments: Imaging Lens System

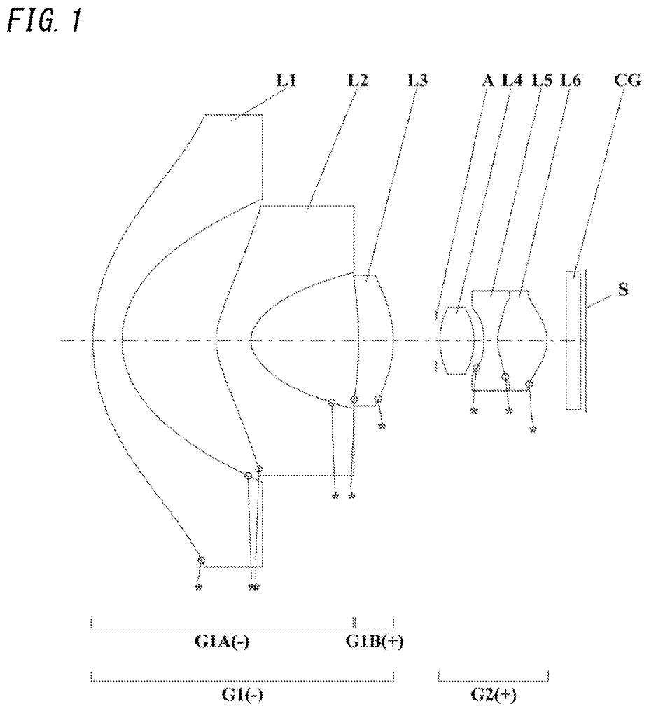

FIGS. 1, 4, 7, 10, and 13 illustrate lens arrangements of an imaging lens system according to first to fifth embodiments, respectively. In these drawings, the asterisk (*) attached to a surface of a particular lens indicates that the surface is an aspheric surface. Also, in these drawings, if no asterisk (*) is attached to an object-side surface or image-side surface of a lens, then the surface is a spherical surface. Furthermore, in these drawings, the straight line drawn at the right end indicates the position of the image plane S. Furthermore, an “optical surface radius” as used herein refers to the radius of either a region of an object-side surface or an image-side surface where a spherical surface is present or a region thereof where an aspheric surface is present. Note that the aspect ratio is the same in each of these drawings.

Furthermore, the signs (+) and (−) added to the reference signs of the respective lens groups (G1, G2) or sub-lens groups (G1A, G1B) indicate the powers of the respective lens groups G1, G2 or sub-lens groups G1A, G1B. That is to say, the positive sign (+) indicates positive power, and the negative sign (−) indicates negative power.

### First Embodiment

FIG. 1 illustrates an imaging lens system according to a first embodiment.

The imaging lens system according to the first embodiment includes: a first lens group G1 having negative power; an aperture stop A; and a second lens group G2 having positive power. A cover glass CG is further provided for the imaging lens system. The first lens group G1, the aperture stop A, the second lens group G2, and the cover glass CG are arranged in this order such that the first lens group G1 is located closer to an object than the aperture stop A, the second lens group G2, or the cover glass CG is and that the cover glass CG is located closer to an image than the first lens group G1, the aperture stop A, or the second lens group G2 is. Note that a first lens L1 is located closest to the object and an image plane S is defined on the image.

The respective lens groups will be described one by one.

The first lens group G1 includes a sub-lens group G1A having negative power and a sub-lens group G1B having positive power. The sub-lens group G1A and the sub-lens group G1B are arranged in this order such that the sub-lens group G1A is located closer to the object than the sub-lens group G1B is and that the sub-lens group G1B is located closer to the image than the sub-lens group G1A is.

The sub-lens group G1A includes: a first lens L1 having negative power; and a second lens L2 having negative power. The first lens L1 and the second lens L2 are arranged in this order such that the first lens L1 is located closer to the object than the second lens L2 is and that the second lens L2 is located closer to the image than the first lens L1 is.

The sub-lens group G1B includes a third lens L3 having positive power.

The second lens group G2 includes: a fourth lens L4 having positive power; a fifth lens L5 having negative power; and a sixth lens L6 having positive power. The fourth lens L4, the fifth lens L5, and the sixth lens L6 are arranged in this order such that the fourth lens L4 is located closer to the object than the fifth lens L5 or the sixth lens L6 is and that the sixth lens L6 is located closer to the image than the fourth lens L4 or the fifth lens L5 is.

The respective lenses will be described one by one.

The first lens L1 is a meniscus lens having a convex object-side surface. The first lens L1 has an aspheric shape on both surfaces thereof along the optical axis. Specifically, an object-side convex surface of the first lens L1 and an image-side concave surface of the first lens L1 are each an aspheric surface, of which the optical surface radius is greater than the absolute value of the paraxial radius of curvature.

The second lens L2 is a meniscus lens having a convex object-side surface. The second lens L2 has an aspheric shape on both surfaces thereof along the optical axis. Specifically, an object-side convex surface of the second lens L2 and an image-side concave surface of the second lens L2 are each an aspheric surface, of which the optical surface radius is greater than the absolute value of the paraxial radius of curvature.

The third lens L3 is a meniscus lens having a convex image-side surface. The third lens L3 has an aspheric shape on both surfaces thereof along the optical axis. An image-side convex surface of the third lens L3 is an aspheric surface, of which the positive power decreases as the distance from the optical axis increases.

The fourth lens L4 is a biconvex lens.

The fifth lens L5 is a biconcave lens. The fifth lens L5 has an aspheric shape on both surfaces thereof along the optical axis.

The sixth lens L6 is a biconvex lens. The sixth lens L6 has an aspheric shape on both surfaces thereof along the optical axis. An image-side convex surface of the sixth lens L6 is an aspheric surface, of which the positive power decreases as the distance from the optical axis increases.

The fifth lens L5 and the sixth lens L6 are bonded together with an adhesive, for example, to form a bonded lens. In other words, the bonded lens includes the fifth lens L5 and the sixth lens L6.

### Second Embodiment

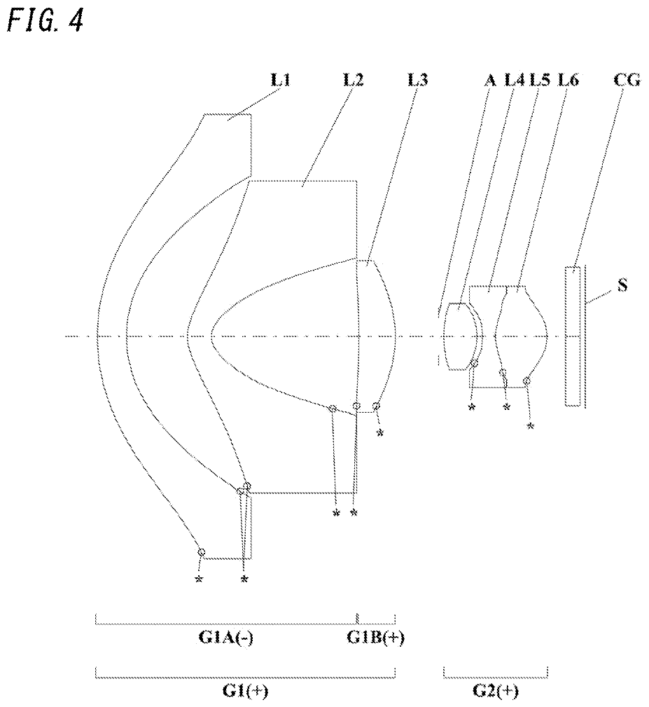

FIG. 4 illustrates an imaging lens system according to a second embodiment.

The imaging lens system according to the second embodiment includes: a first lens group G1 having positive power; an aperture stop A; and a second lens group G2 having positive power. A cover glass CG is further provided for the imaging lens system. The first lens group G1, the aperture stop A, the second lens group G2, and the cover glass CG are arranged in this order such that the first lens group G1 is located closer to an object than the aperture stop A, the second lens group G2, or the cover glass CG is and that the cover glass CG is located closer to an image than the first lens group G1, the aperture stop A, or the second lens group G2 is. Note that a first lens L1 is located closest to the object and an image plane S is defined on the image.

The respective lens groups will be described one by one.

The first lens group G1 includes: a sub-lens group G1A having negative power; and a sub-lens group G1B having positive power. The sub-lens group G1A and the sub-lens group G1B are arranged in this order such that the sub-lens group G1A is located closer to the object than the sub-lens group G1B is and that the sub-lens group G1B is located closer to the image than the sub-lens group G1A is.

The sub-lens group G1A includes: a first lens L1 having negative power; and a second lens L2 having negative power. The first lens L1 and the second lens L2 are arranged in this order such that the first lens L1 is located closer to the object than the second lens L2 is and that the second lens L2 is located closer to the image than the first lens L1 is.

The sub-lens group G1B includes a third lens L3 having positive power.

The second lens group G2 includes: a fourth lens L4 having positive power; a fifth lens L5 having negative power; and a sixth lens L6 having positive power. The fourth lens L4, the fifth lens L5, and the sixth lens L6 are arranged in this order such that the fourth lens L4 is located closer to the object than the fifth lens L5 or the sixth lens L6 is and that the sixth lens L6 is located closer to the image than the fourth lens L4 or the fifth lens L5 is.

The respective lenses will be described one by one.

The first lens L1 is a meniscus lens having a convex object-side surface. The first lens L1 has an aspheric shape on both surfaces thereof along the optical axis. Specifically, an object-side convex surface of the first lens L1 and an image-side concave surface of the first lens L1 are each an aspheric surface, of which the optical surface radius is greater than the absolute value of the paraxial radius of curvature.

The second lens L2 is a meniscus lens having a convex object-side surface. The second lens L2 has an aspheric shape on both surfaces thereof along the optical axis. Specifically, an object-side convex surface of the second lens L2 and an image-side concave surface of the second lens L2 are each an aspheric surface, of which the optical surface radius is greater than the absolute value of the paraxial radius of curvature.

The third lens L3 is a meniscus lens having a convex image-side surface. The third lens L3 has an aspheric shape on both surfaces thereof along the optical axis. An image-side convex surface of the third lens L3 is an aspheric surface, of which the positive power decreases as the distance from the optical axis increases.

The fourth lens L4 is a biconvex lens.

The fifth lens L5 is a biconcave lens. The fifth lens L5 has an aspheric shape on both surfaces thereof along the optical axis.

The sixth lens L6 is a biconvex lens. The sixth lens L6 has an aspheric shape on both surfaces thereof along the optical axis. An image-side convex surface of the sixth lens L6 is an aspheric surface, of which the positive power decreases as the distance from the optical axis increases.

The fifth lens L5 and the sixth lens L6 are bonded together with an adhesive, for example, to form a bonded lens. In other words, the bonded lens includes the fifth lens L5 and the sixth lens L6.

### Third Embodiment

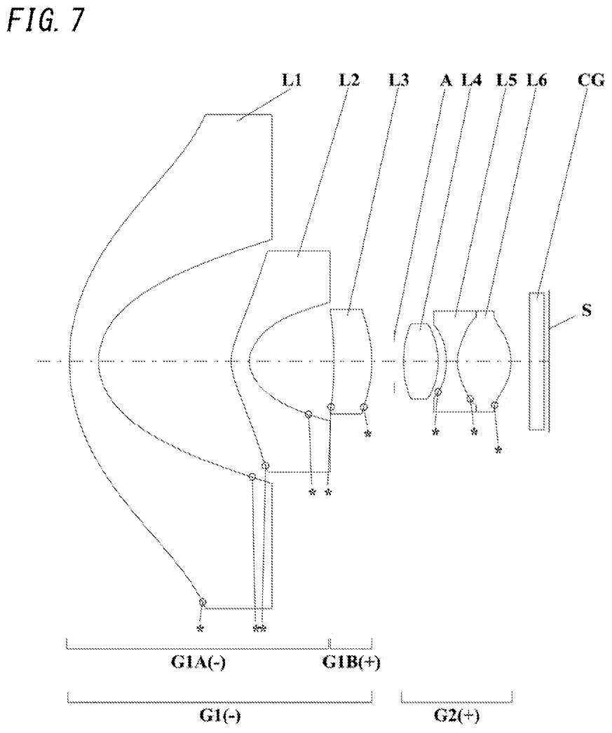

FIG. 7 illustrates an imaging lens system according to a third embodiment.

The imaging lens system according to the third embodiment includes: a first lens group G1 having negative power; an aperture stop A; and a second lens group G2 having positive power. A cover glass CG is further provided for the imaging lens system. The first lens group G1, the aperture stop A, the second lens group G2, and the cover glass CG are arranged in this order such that the first lens group G1 is located closer to an object than the aperture stop A, the second lens group G2, or the cover glass CG is and that the cover glass CG is located closer to an image than the first lens group G1, the aperture stop A, or the second lens group G2 is. Note that a first lens L1 is located closest to the object and an image plane S is defined on the image.

The respective lens groups will be described one by one.

The first lens group G1 includes: a sub-lens group G1A having negative power; and a sub-lens group G1B having positive power. The sub-lens group G1A and the sub-lens group G1B are arranged in this order such that the sub-lens group G1A is located closer to the object than the sub-lens group G1B is and that the sub-lens group G1B is located closer to the image than the sub-lens group G1A is.

The sub-lens group G1A includes: a first lens L1 having negative power; and a second lens L2 having negative power. The first lens L1 and the second lens L2 are arranged in this order such that the first lens L1 is located closer to the object than the second lens L2 is and that the second lens L2 is located closer to the image than the first lens L1 is.

The sub-lens group G1B includes a third lens L3 having positive power.

The second lens group G2 includes: a fourth lens L4 having positive power; a fifth lens L5 having negative power; and a sixth lens L6 having positive power. The fourth lens L4, the fifth lens L5, and the sixth lens L6 are arranged in this order such that the fourth lens L4 is located closer to the object than the fifth lens L5 or the sixth lens L6 is and that the sixth lens L6 is located closer to the image than the fourth lens L4 or the fifth lens L5 is.

The respective lenses will be described one by one.

The first lens L1 is a meniscus lens having a convex object-side surface. The first lens L1 has an aspheric shape on both surfaces thereof along the optical axis. Specifically, an object-side convex surface of the first lens L1 and an image-side concave surface of the first lens L1 are each an aspheric surface, of which the optical surface radius is greater than the absolute value of the paraxial radius of curvature.

The second lens L2 is a meniscus lens having a convex object-side surface. The second lens L2 has an aspheric shape on both surfaces thereof along the optical axis. Specifically, an object-side convex surface of the second lens L2 and an image-side concave surface of the second lens L2 are each an aspheric surface, of which the optical surface radius is greater than the absolute value of the paraxial radius of curvature.

The third lens L3 is a meniscus lens having a convex image-side surface. The third lens L3 has an aspheric shape on both surfaces thereof along the optical axis. An image-side convex surface of the third lens L3 is an aspheric surface, of which the positive power decreases as the distance from the optical axis increases.

The fourth lens L4 is a biconvex lens.

The fifth lens L5 is a biconcave lens. The fifth lens L5 has an aspheric shape on both surfaces thereof along the optical axis.

The sixth lens L6 is a biconvex lens. The sixth lens L6 has an aspheric shape on both surfaces thereof along the optical axis. An image-side convex surface of the sixth lens L6 is an aspheric surface, of which the positive power decreases as the distance from the optical axis increases.

The fifth lens L5 and the sixth lens L6 are bonded together with an adhesive, for example, to form a bonded lens. In other words, the bonded lens includes the fifth lens L5 and the sixth lens L6.

### Fourth Embodiment

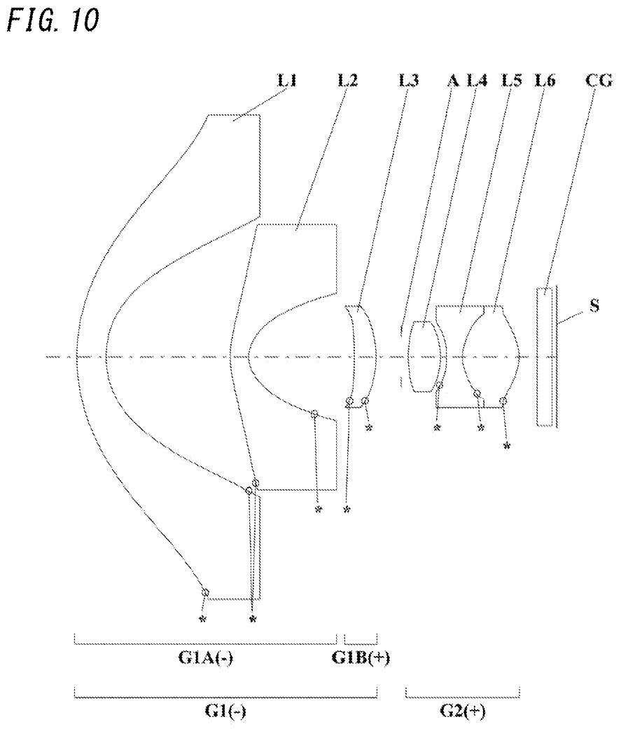

FIG. 10 illustrates an imaging lens system according to a fourth embodiment.

The imaging lens system according to the fourth embodiment includes: a first lens group G1 having negative power; an aperture stop A; and a second lens group G2 having positive power. A cover glass CG is further provided for the imaging lens system. The first lens group G1, the aperture stop A, the second lens group G2, and the cover glass CG are arranged in this order such that the first lens group G1 is located closer to an object than the aperture stop A, the second lens group G2, or the cover glass CG is and that the cover glass CG is located closer to an image than the first lens group G1, the aperture stop A, or the second lens group G2 is. Note that a first lens L1 is located closest to the object and an image plane S is defined on the image.

The respective lens groups will be described one by one.

The first lens group G1 includes: a sub-lens group G1A having negative power; and a sub-lens group G1B having positive power. The sub-lens group G1A and the sub-lens group G1B are arranged in this order such that the sub-lens group G1A is located closer to the object than the sub-lens group G1B is and that the sub-lens group G1B is located closer to the image than the sub-lens group G1A is.

The sub-lens group G1A includes: a first lens L1 having negative power; and a second lens L2 having negative power. The first lens L1 and the second lens L2 are arranged in this order such that the first lens L1 is located closer to the object than the second lens L2 is and that the second lens L2 is located closer to the image than the first lens L1 is.

The sub-lens group G1B includes a third lens L3 having positive power.

The second lens group G2 includes: a fourth lens L4 having positive power; a fifth lens L5 having negative power; and a sixth lens L6 having positive power. The fourth lens L4, the fifth lens L5, and the sixth lens L6 are arranged in this order such that the fourth lens L4 is located closer to the object than the fifth lens L5 or the sixth lens L6 is and that the sixth lens L6 is located closer to the image than the fourth lens L4 or the fifth lens L5 is.

The respective lenses will be described one by one.

The first lens L1 is a meniscus lens having a convex object-side surface. The first lens L1 has an aspheric shape on both surfaces thereof along the optical axis. Specifically, an object-side convex surface of the first lens L1 and an image-side concave surface of the first lens L1 are each an aspheric surface, of which the optical surface radius is greater than the absolute value of the paraxial radius of curvature.

The second lens L2 is a meniscus lens having a convex object-side surface. The second lens L2 has an aspheric shape on both surfaces thereof along the optical axis. Specifically, an object-side convex surface of the second lens L2 and an image-side concave surface of the second lens L2 are each an aspheric surface, of which the optical surface radius is greater than the absolute value of the paraxial radius of curvature.

The third lens L3 is a meniscus lens having a convex image-side surface. The third lens L3 has an aspheric shape on both surfaces thereof along the optical axis. An object-side concave surface of the third lens L3 is an aspheric surface, of which the negative power increases as the distance from the optical axis increases. An image-side convex surface of the third lens L3 is an aspheric surface, of which the positive power increases as the distance from the optical axis increases.

The fourth lens L4 is a biconvex lens.

The fifth lens L5 is a biconcave lens. The fifth lens L5 has an aspheric shape on both surfaces thereof along the optical axis.

The sixth lens L6 is a biconvex lens. The sixth lens L6 has an aspheric shape on both surfaces thereof along the optical axis. An image-side convex surface of the sixth lens L6 is an aspheric surface, of which the positive power decreases as the distance from the optical axis increases.

The fifth lens L5 and the sixth lens L6 are bonded together with an adhesive, for example, to form a bonded lens. In other words, the bonded lens includes the fifth lens L5 and the sixth lens L6.

### Fifth Embodiment

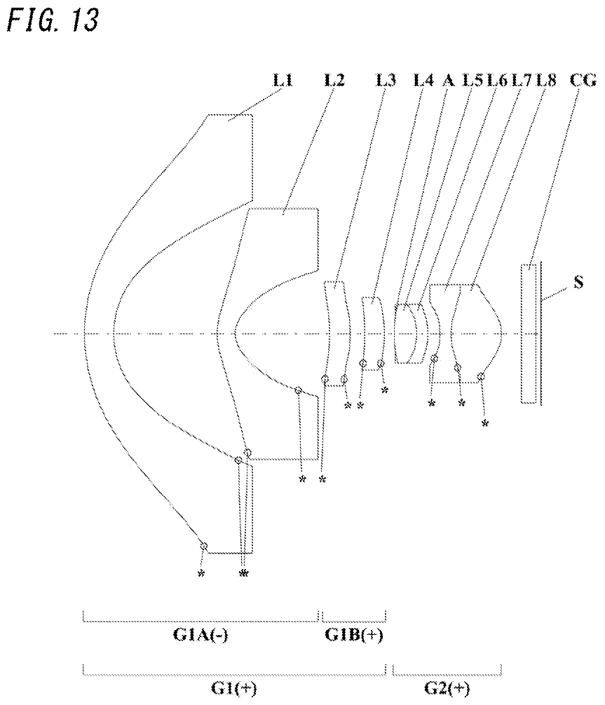

FIG. 13 illustrates an imaging lens system according to a fifth embodiment.

The imaging lens system according to the fifth embodiment includes: a first lens group G1 having positive power; an aperture stop A; and a second lens group G2 having positive power. A cover glass CG is further provided for the imaging lens system. The first lens group G1, the aperture stop A, the second lens group G2, and the cover glass CG are arranged in this order such that the first lens group G1 is located closer to an object than the aperture stop A, the second lens group G2, or the cover glass CG is and that the cover glass CG is located closer to an image than the first lens group G1, the aperture stop A, or the second lens group G2 is. Note that a first lens L1 is located closest to the object and an image plane S is defined on the image.

The respective lens groups will be described one by one.

The first lens group G1 includes: a sub-lens group G1A having negative power; and a sub-lens group G1B having positive power. The sub-lens group G1A and the sub-lens group G1B are arranged in this order such that the sub-lens group G1A is located closer to the object than the sub-lens group G1B is and that the sub-lens group G1B is located closer to the image than the sub-lens group G1A is.

The sub-lens group G1A includes: a first lens L1 having negative power; and a second lens L2 having negative power. The first lens L1 and the second lens L2 are arranged in this order such that the first lens L1 is located closer to the object than the second lens L2 is and that the second lens L2 is located closer to the image than the first lens L1 is.

The sub-lens group G1B includes a third lens L3 having positive power and a fourth lens L4 having positive power. The third lens L3 and the fourth lens L4 are arranged in this order such that the third lens L3 is located closer to the object than the fourth lens L4 is and that the fourth lens L4 is located closer to the image than the third lens L3 is.

The second lens group G2 includes: a fifth lens L5 having positive power; a sixth lens L6 having negative power; a seventh lens L7 having negative power; and an eighth lens L8 having positive power. The fifth lens L5, the sixth lens L6, the seventh lens L7, and the eighth lens L8 are arranged in this order such that the fifth lens L5 is located closer to the object than the sixth lens L6, the seventh lens L7, or the eighth lens L8 is and that the eighth lens L8 is located closer to the image than the fifth lens L5, the sixth lens L6, or the seventh lens L7 is.

The respective lenses will be described one by one.

The first lens L1 is a meniscus lens having a convex object-side surface. The first lens L1 has an aspheric shape on both surfaces thereof along the optical axis. Specifically, an object-side convex surface of the first lens L1 and an image-side concave surface of the first lens L1 are each an aspheric surface, of which the optical surface radius is greater than the absolute value of the paraxial radius of curvature.

The second lens L2 is a meniscus lens having a convex object-side surface. The second lens L2 has an aspheric shape on both surfaces thereof along the optical axis. Specifically, an object-side convex surface of the second lens L2 and an image-side concave surface of the second lens L2 are each an aspheric surface, of which the optical surface radius is greater than the absolute value of the paraxial radius of curvature.

The third lens L3 is a meniscus lens having a convex image-side surface. The third lens L3 has an aspheric shape on both surfaces thereof along the optical axis. An object-side concave surface of the third lens L3 is an aspheric surface, of which the negative power decreases as the distance from the optical axis increases. An image-side convex surface of the third lens L3 is an aspheric surface, of which the positive power decreases as the distance from the optical axis increases.

The fourth lens L4 is a meniscus lens having a convex image-side surface. The fourth lens L4 has an aspheric shape on both surfaces thereof along the optical axis. An image-side convex surface of the fourth lens L4 is an aspheric surface, of which the positive power increases as the distance from the optical axis increases.

The fifth lens L5 is a biconvex lens.

The sixth lens L6 is a meniscus lens having an image-side convex surface.

The seventh lens L7 is a biconcave lens. The seventh lens L7 has an aspheric shape on both surfaces thereof along the optical axis.

The eighth lens L8 is a biconvex lens. The eighth lens L8 has an aspheric shape on both surfaces thereof along the optical axis. An image-side convex surface of the eighth lens L8 is an aspheric surface, of which the positive power decreases as the distance from the optical axis increases.

The fifth lens L5 and the sixth lens L6 are bonded together with an adhesive, for example, to form a first bonded lens. In other words, the first bonded lens includes the fifth lens L5 and the sixth lens L6.

The seventh lens L7 and the eighth lens L8 are bonded together with an adhesive, for example, to form a second bonded lens. In other words, the second bonded lens includes the seventh lens L7 and the eighth lens L8.

(Conditions and Advantages)

Next, beneficial conditions that an imaging lens system such as the ones according to the first to fifth embodiments described above preferably satisfies will be described. That is to say, a plurality of beneficial conditions may be defined for the imaging lens system according to each of these five embodiments. In that case, an imaging lens system, of which the configuration satisfies all of these conditions, is most advantageous. Alternatively, an imaging lens system that achieves its expected advantages by satisfying any of the individual conditions to be described below may also be obtained.

An imaging lens system according to the present disclosure, such as the imaging lens systems according to the first to fifth embodiments described above, includes: a first lens group G1; an aperture stop A; and a second lens group G2 having positive power. The first lens group G1, the aperture stop A, and the second lens group G2 are arranged in this order such that the first lens group G1 is located closer to an object than the aperture stop A or the second lens group G2 is and that the second lens group G2 is located closer to an image than the first lens group G1 or the aperture stop A is. The first lens group G1 includes: a first lens L1 having negative power; a second lens L2 having negative power; and a sub-lens group G1B having positive power. The first lens L1, the second lens L2, and the sub-lens group G1B are arranged in this order such that the first lens L1 is located closer to the object than the second lens L2 or the sub-lens group G1B is and that the sub-lens group G1B is located closer to the image than the first lens L1 or the second lens L2 is. The first lens L1 is a negative meniscus lens having a surface convex toward the object. The second lens L2 is a negative meniscus lens having a surface convex toward the object.

The imaging lens system preferably satisfies the conditions expressed by the following inequalities (1) and (2):

0.35<T2/R2<4.0 (1)

3.0<T4/R4<10.0 (2)

where R2 is a radius of curvature of an image-side surface of the first lens L1, R4 is a radius of curvature of an image-side surface of the second lens L2, T2 is a distance on an optical axis between the image-side surface of the first lens L1 and an object-side surface of the second lens L2, and T4 is a distance on the optical axis between the image-side surface of the second lens L2 and an object-side surface of a lens (third lens L3) belonging to the sub-lens group G1B and located closer to the object than any other lens belonging to the sub-lens group GIB.

These inequalities (1) and (2) define conditions that are preferably satisfied to achieve both downsizing and manufacturing efficiency while ensuring sufficient resolution for a toroidal area of a captured image formed by the optical system (imaging lens system).

Satisfying the condition expressed by the inequality (1) would establish appropriate relation between the interval from the first lens L1 to the second lens L2 and the radius of curvature of the image-side surface of the first lens L1, thus enabling downsizing the optical system and improving the manufacturing efficiency of the second lens L2.

If the T2/R2 ratio were equal to or less than the lower limit value defined by this inequality (1), then the negative power of the first lens L1 would decrease, and the effective diameter would increase on both surfaces of the second lens L2. In particular, the tilt angle in the vicinity of the effective diameter of the image-side surface would increase so much in the second lens L2 as to make it difficult to manufacture the second lens L2.

On the other hand, if the T2/R2 ratio were equal to or greater than the upper limit value defined by this inequality (1), then the effective diameter of the first lens L1 would increase too much to downsize the optical system easily.

Satisfying the condition expressed by the inequality (2) would establish appropriate relation between the interval from the second lens L2 to the sub-lens group G1B following the second lens L2 and having positive power and the radius of curvature of the image-side surface of the second lens L2, thus enabling downsizing the optical system and improving the manufacturing efficiency of the lens.

If the T4/R4 ratio were equal to or less than the lower limit value defined by this inequality (2), then the effective diameter of the first lens L1 would increase so much as to make it difficult to downsize the optical system.

If the T4/R4 ratio were equal to or greater than the upper limit value defined by this inequality (2), then the effective diameter would increase on both surfaces of the second lens L2. In particular, the tilt angle in the vicinity of the effective diameter of the image-side surface would increase so much in the second lens L2 as to make it difficult to manufacture the second lens L2.

In this case, at least one (and preferably both) of the conditions expressed by the following inequalities (1a) and (2a) is/are preferably satisfied within the ranges defined by the inequalities (1) and (2):

0.4<T2/R2<3.0 (1a)

3.5<T4/R4<9.0 (2a)

This would enhance the advantages described above.

Also, at least one (and preferably both) of the conditions expressed by the following inequalities (1b) and (2b) is/are preferably satisfied within the ranges defined by the inequalities (1) and (2):

0.5<T2/R2<2.2 (1b)

3.75<T4/R4<8.0 (2b)

This would further enhance the advantages described above.

Also, the imaging lens system preferably satisfies, for example, the condition expressed by the following inequality (3):

(R3+R2)/(R3−R2)<−1.0 (3)

where R2 is the radius of curvature of the image-side surface of the first lens L1 and R3 is a radius of curvature of the object-side surface of the second lens L2.

The inequality (3) expresses a condition for defining an appropriate range of a shaping factor of an air lens between the first lens L1 and the second lens L2.

Satisfying the condition expressed by the inequality (3) enables making appropriate correction mainly to astigmatism. If the (R3+R2)/(R3−R2) ratio were equal to or greater than the upper limit value defined by this inequality (3), then the radius of curvature would decrease so much on both surfaces of the second lens L2 as to make it difficult to make appropriate correction to the astigmatism.

In this case, the condition expressed by the following inequality (3a) is preferably satisfied within the range defined by the inequality (3):

(R3+R2)/(R3−R2)<−1.5 (3a)

This would enhance the advantages described above.

The condition expressed by the following inequality (3b) is more preferably satisfied within the range defined by the inequality (3):

(R3+R2)/(R3−R2)<−2.0 (3b)

This would further enhance the advantages described above.

Also, the imaging lens system preferably satisfies, for example, the condition expressed by the following inequality (4):

|f/f1|<0.2 (4)

where f is a focal length of the overall imaging lens system in response to a d-line and f1 is a focal length of the first lens group G1 in response to the d-line.

The inequality (4) expresses a condition for defining an appropriate power range of the first lens group G1.

Satisfying the condition expressed by the inequality (4) enables making appropriate correction mainly to spherical aberration.

Meanwhile, if f/f1 were equal to or greater than the upper limit value defined by the inequality (4) or equal to or less than the lower limit value defined by the inequality (4), then the power of the sub-lens group G1B having positive power in the first lens group G1 would be so high or so low as to make it difficult to make appropriate correction to the spherical aberration.

In this case, the condition expressed by the following inequality (4a) is preferably satisfied within the range defined by the inequality (4):

|f/f1|<0.15 (4a)

This would enhance the advantages described above.

The condition expressed by the following inequality (4b) is more preferably satisfied within the range defined by the inequality (4):

|f/f1|<0.11 (4b)

This would further enhance the advantages described above.

Furthermore, the imaging lens system preferably satisfies, for example, the condition expressed by the following inequality (5):

0.2<f/f2<0.4 (5)

where f is a focal length of the overall imaging lens system in response to a d-line and f2 is a focal length of the second lens group G2 in response to the d-line.

The inequality (5) expresses a condition for defining an appropriate power range of the second lens group G2.

Satisfying the condition expressed by the inequality (5) enables downsizing the optical system while ensuring an appropriate back focus.

However, if f/f2 were equal to or less than the lower limit value defined by the inequality (5), then the power of the second lens group G2 would be so low as to make the overall length of the optical system too long to downsize the imaging lens system easily.

Meanwhile, if f/f2 were equal to or greater than the upper limit value defined by the inequality (5), then the power of the second lens group G2 would be so high as to make it difficult to ensure an appropriate back focus.

Also, at least one (and preferably both) of the conditions expressed by the following inequalities (5a) and (5b) is/are preferably satisfied within the ranges defined by the inequality (5):

0.25<f/f2 (5a)

f/f2<0.35 (5b)

This would enhance the advantages described above.

Furthermore, at least one (and preferably both) of the conditions expressed by the following inequalities (5c) and (5d) is/are preferably satisfied within the ranges defined by the inequality (5):

0.27<f/f2 (5c)

f/f2<0.33 (5d)

This would further enhance the advantages described above.

Furthermore, the imaging lens system preferably satisfies, for example, the condition expressed by the following inequality (6):

υ1>25 (6)

where υ1 is an Abbe number of the first lens L1 in response to a d-line.

The inequality (6) expresses a condition for defining an appropriate Abbe number range of the first lens L1.

Satisfying the condition expressed by the inequality (6) enables making appropriate correction mainly to chromatic aberration of magnification.

If υ1 were less than the lower limit value defined by the inequality (6), then it would be difficult to make appropriate correction to the chromatic aberration of magnification.

In this case, the condition expressed by the following inequality (6a) is preferably satisfied within the range defined by the inequality (6):

υ1>27 (6a)

This would enhance the advantages described above.

The condition expressed by the following inequality (6b) is more preferably satisfied within the range defined by the inequality (6):

ϕ1>29 (6b)

This would further enhance the advantages described above.

The second lens group G2 of the imaging lens system includes first through N^{th} lenses, each having positive power, where N is an integer equal to or greater than one. For example, in the first embodiment, the second lens group G2 includes a fourth lens L4 having positive power (as a first lens) and a sixth lens L6 having positive power (as a second lens) and N=2. In the fifth embodiment, for example, the second lens group G2 includes a fifth lens L5 having positive power (as a first lens) and an eighth lens L8 having positive power (as a second lens) and N=2. At least one integer i out of one or more integers i that meet 1≤i≤N preferably satisfies the condition expressed by the following inequality (7). More preferably, each of the one or more integers i satisfies the condition expressed by the following inequality (7):

υ2pi>50 (7)

where υ2pi is an Abbe number of an i^{th} lens belonging to the second lens group G2 and having positive power in response to a d-line.

If the second lens group G2 includes, as lenses each having positive power, a first lens, a second lens, and a third lens, for example, at least one lens out of those first to third lenses preferably satisfies the condition expressed by the inequality (7).

The inequality (7) expresses a condition for defining an appropriate Abbe number range of at least one positive lens (i.e., a lens having positive power) included in the second lens group G2.

Satisfying the condition expressed by the inequality (7) enables making appropriate correction to an axial chromatic aberration and a chromatic aberration of magnification.

If υ2pi were equal to or less than the lower limit value defined by the inequality (7), then it would be difficult to make appropriate correction to the axial chromatic aberration and chromatic aberration of magnification.

In this case, the condition expressed by the following inequality (7a) is preferably satisfied within the range defined by the inequality (7):

υ2pi>52 (7a)

This would enhance the advantages described above.

The condition expressed by the following inequality (7b) is more preferably satisfied within the range defined by the inequality (7):

υ2pi>54 (7b)

This would further enhance the advantages described above.

Note that if the second lens group G2 includes a plurality of positive lenses, the larger the number of the positive lenses that satisfy the condition expressed by the inequality (7) is, the more significantly the advantages described above would be achieved. Thus, if the second lens group G2 includes, as lenses each having positive power, a first lens, a second lens, and a third lens, for example, each of those first to third lenses preferably satisfies the condition expressed by the inequality (7).

Furthermore, the imaging lens system preferably satisfies, for example, the condition expressed by the following inequality (8):

15<T/f<26 (8)

where f is a focal length of the overall imaging lens system in response to a d-line and T is a total lens length of the imaging lens system.

As used herein, the “total lens length” refers to a distance between an object-side surface of a lens belonging to a plurality of lenses included in the imaging lens system and located closer to the object than any other one of the plurality of lenses and the image plane S.

The inequality (8) expresses a condition for defining an appropriate total lens length range.

Satisfying the condition expressed by the inequality (8) enables downsizing the optical system while compensating for various types of aberrations sufficiently.

If T/f were equal to or less than the lower limit value defined by the inequality (8), then the power of each lens would increase so much as to make it difficult to compensate for various types of aberrations appropriately.

On the other hand, if T/f were equal to or greater than the upper limit value defined by the inequality (8), then the total lens length would increase so much as to make it difficult to downsize the optical system.

Also, at least one (and preferably both) of the conditions expressed by the following inequalities (8a) and (8b) is/are preferably satisfied within the ranges defined by the inequality (8):

17<T/f (8a)

T/f<24 (8b)

This would enhance the advantages described above.

Furthermore, at least one (and preferably both) of the conditions expressed by the following inequalities (8c) and (8d) is/are preferably satisfied within the ranges defined by the inequality (8):

19<T/f (8c)

T/f<22 (8d)

This would further enhance the advantages described above.

Furthermore, in the imaging lens system, at least one of the object-side convex surface of the first lens L1 or the image-side concave surface of the first lens L1, for example, is preferably an aspheric surface, of which the optical surface radius is greater than the absolute value of the paraxial radius of curvature.

This enables making the positive or negative power at an end of the effective diameter of each surface lower than the paraxial one thereof, thus enabling producing, on the toroidal area of the captured image formed by the imaging lens system, significant positive distortion and thereby magnifying the subject image.

Furthermore, in the imaging lens system, the image-side convex surface of a lens located closest to the image, for example, preferably has an aspheric shape, of which the positive power decreases as the distance from the optical axis increases.

This enables making appropriate correction to coma aberration.

### Sixth Embodiment: Camera

A camera including the imaging lens system according to the first embodiment will be described as being applied to an onboard camera as an example. Note that any one of the imaging lens systems according to the second, third, fourth, and fifth embodiments is also applicable to the onboard camera instead of the imaging lens system according to the first embodiment.

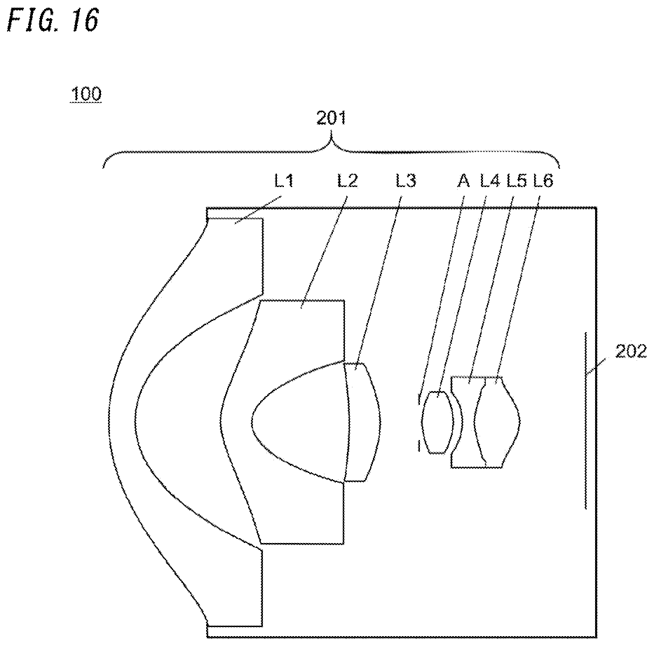

FIG. 16 is a schematic representation of an onboard camera including the imaging lens system according to the first embodiment.

The onboard camera 100 includes an imaging lens system 201 for forming an optical image of an object and an image sensor 202 for transforming the optical image formed by the imaging lens system 201 into an electrical image signal. The image sensor 202 is disposed at the image plane S of the imaging lens system according to the first embodiment.

The onboard camera 100 may be disposed on any of the front, rear, right, and left sides of a vehicle, for example, and may be used as a sensing camera, a view camera, or an around-view camera. Optionally, a plurality of onboard cameras 100 may be arranged on the front, rear, right, and/or left sides of the vehicle, for example.

An image captured by the sensing camera may be used to check the distance from the driver's vehicle to another vehicle. Alternatively, the image captured by the sensing camera may also be used to either detect another vehicle approaching his or her vehicle or any other object that could be a danger to his or her vehicle or check the distance to such an object by analyzing and recognizing the image. An image captured by the view camera is displayed on a monitor inside the vehicle and used for the driver to watch the surroundings in front of, behind, and beside his or her vehicle.

The image signal generated by the image sensor 202 may be displayed on, for example, a display device, which may be disposed on a front side of the vehicle cabin. In addition, the image signal is also stored as image data in a memory, for example.

The image data may also be used to detect an object. The onboard camera 100 according to this embodiment has so wide an angle of view that the image data generated by the onboard camera 100 represents an image similar to the one captured through a so-called “fisheye lens.” The onboard camera 100 according to this embodiment may achieve a higher resolution for the toroidal area of the captured image formed by the imaging lens system, in particular, than a general fisheye lens does. This enables, even if the onboard camera 100 is installed with its optical axis oriented vertically downward with respect to the vehicle, for example, more accurately analyzing and recognizing an object located horizontally beside the vehicle while analyzing and recognizing an object located perpendicularly under the vehicle. Thus, the number of cameras to be installed on the vehicle may be cut down.

The display device may be an electronic rearview mirror, for example.

Alternatively, the display device may also be a display device for use in a navigation system or a front panel, for example.

This allows the vehicle to display, using the onboard camera 100 including the imaging lens system 201, video representing the surroundings in front of, behind, and right and left sides of, the vehicle, on a display device, for example. This allows the person on board the vehicle (such as the driver of the vehicle) to view the surroundings in front of, behind, and right and left sides of, the vehicle. Alternatively, the results of analysis and recognition of the image captured using the onboard camera 100 may also be superimposed on the image displayed on a display device for use in a navigation system or a front panel.

As can be seen from the foregoing description, the imaging lens system according to the present disclosure is effectively applicable as a lens system for any of a sensing camera, a view camera, or an around-view camera.

The sixth embodiment has been described as an exemplary embodiment of the present disclosure. Note that the embodiment described above is only an example of the present disclosure and should not be construed as limiting. Rather, the exemplary embodiment may be readily modified, replaced, combined with other embodiments, provided with some additional components, or partially omitted without departing from the scope of the present disclosure.

Optionally, a lens having substantially no power may be provided as appropriate as an additional lens for any one of the imaging lens systems according to the first to fifth embodiments.

The aspheric surface shape of the lenses included in the imaging lens systems according to the first to fifth embodiments does not have to be formed by polishing or molding. Alternatively, a so-called “replica lens (hybrid lens)” in which a coating having an aspheric surface is provided on the surface of a spherical lens may also be used as the lens.

The onboard camera 100 including the imaging lens system according to any one of the first to fifth embodiments of the present disclosure achieves a sufficiently high resolution for the toroidal area of the captured image formed by the imaging lens system, in particular. Thus, installing the onboard camera 100 on the hood of the vehicle with the optical axis of the onboard camera 100 oriented perpendicularly upward with respect to the vehicle, for example, enables acquiring image data from a wide range surrounding the vehicle. In addition, installing the onboard camera 100 on each of the right and left side-view mirrors of the vehicle with the optical axis of the onboard camera 100 oriented either perpendicularly downward with respect to the vehicle or tilted slightly outward with respect to the perpendicularly downward direction enables acquiring image data from a wide range surrounding the vehicle while substantially preventing the onboard camera 100 from shooting the vehicle itself and reducing the blind area.

In the foregoing description, an example in which the imaging lens system according to any of the first to fifth embodiments of the present disclosure is applied to an onboard camera as a sensing camera, a view camera, or an around view camera has been described as the sixth embodiment. However, this is only an example and should not be construed as limiting. Alternatively, the imaging lens system according to the present disclosure is naturally applicable as cameras built in smartphones and cellphones, surveillance cameras for surveillance systems, Web cameras, and various other types of cameras as well.

### Examples of Numerical Values

Next, exemplary sets of specific numerical values that were actually adopted in the imaging lens systems with the configurations according to the first, second, third, fourth, and fifth embodiments will be described. Note that in the tables showing these exemplary sets of numerical values, the length is expressed in millimeters (mm), the angle of view is expressed in degrees (°) (the “angle of view” in the tables refers to a horizontal half-angle of view), r indicates the radius of curvature, d indicates the surface interval, nd indicates a refractive index in response to a d-line, υd (also denoted as “vd”) indicates an abbe number in response to a d-line, and a surface with an asterisk (*) is an aspheric surface. The aspheric shape is defined by the following equation:

$$Z = \frac{{h}^{2} / r}{1 + \sqrt{1 - ( 1 + κ ) {( h / r )}^{2}}} + Σ {A}_{n} {h}^{n}$$

where Z is the distance from a point on an aspheric surface, located at a height h as measured from the optical axis, to a tangent plane defined with respect to the vertex of the aspheric surface, h is the height as measured from the optical axis, r is the radius of curvature of the vertex, κ is a conic constant, and Aₙ is an n^{th} order aspheric surface coefficient.

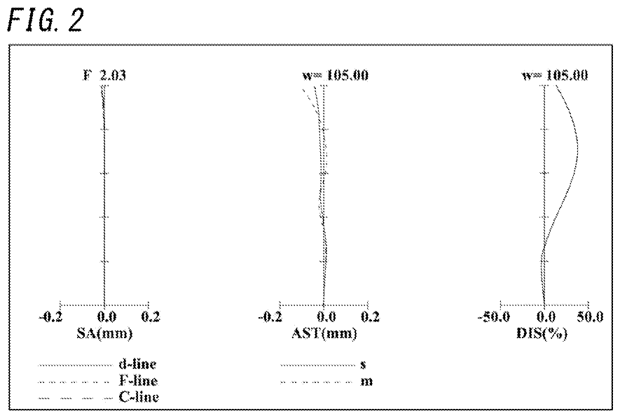

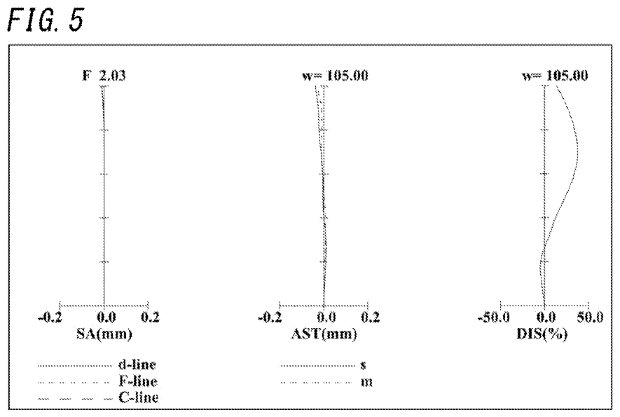

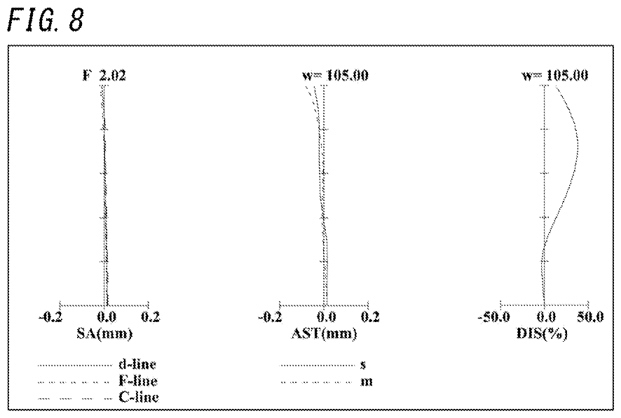

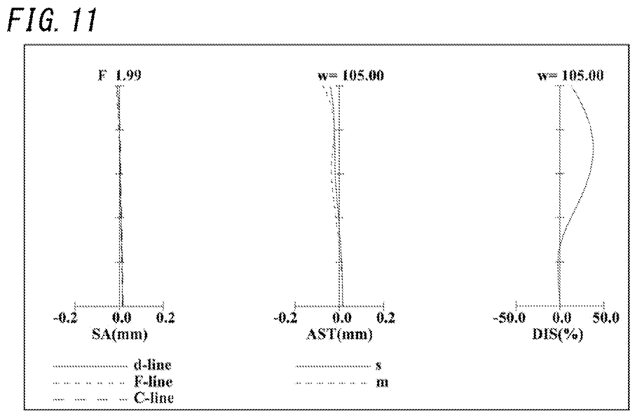

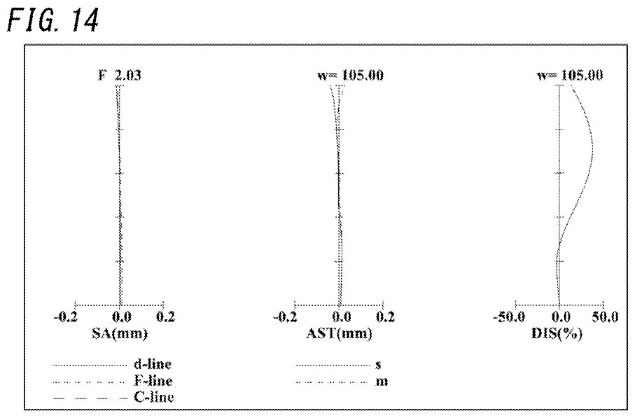

FIGS. 2, 5, 8, 11, and 14 are longitudinal aberration diagrams showing what state the imaging lens systems according to the first, second, third, fourth, and fifth examples of numerical values assume.

Each of these longitudinal aberration diagrams shows spherical aberration (SA (mm)), astigmatism (AST (mm)), and distortion (DIS (%)) in this order from left to right.

In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line.

In each astigmatism diagram, the ordinate indicates the image height, the solid curve indicates a characteristic with respect to a sagittal plane (designated by “s” on the drawings), and the dotted curve indicates a characteristic with respect to a meridional plane (designated by “m” on the drawings). Note that ω (also denoted as “w”) indicates a half-angle of view.

Furthermore, in each distortion diagram, the ordinate indicates the image height and ω (also denoted as “w”) indicates a half-angle of view.

In each distortion diagram, the solid line indicates the aberration in a situation where Y=2·f·tan (ω/2) (where Y is the image height and f is the focal length of the overall imaging lens system) is supposed to be an ideal image height.

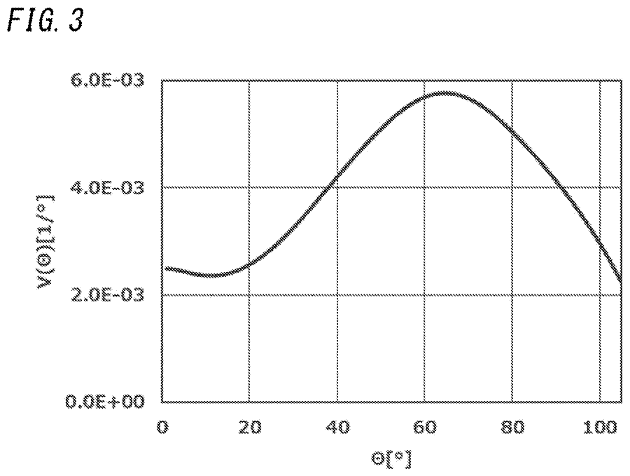

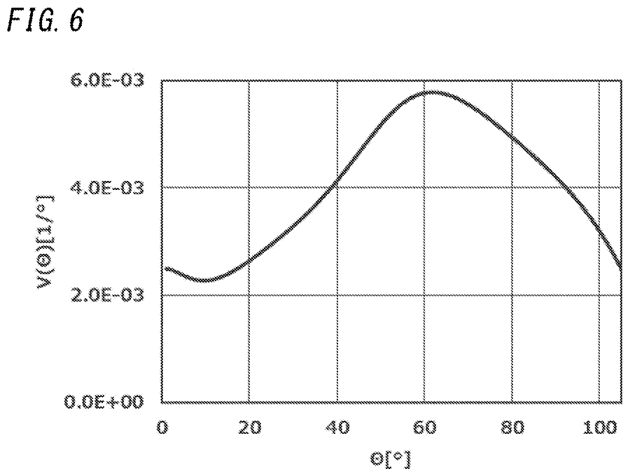

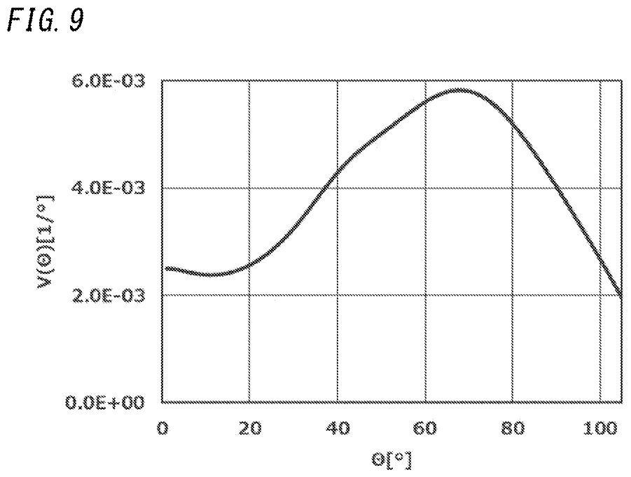

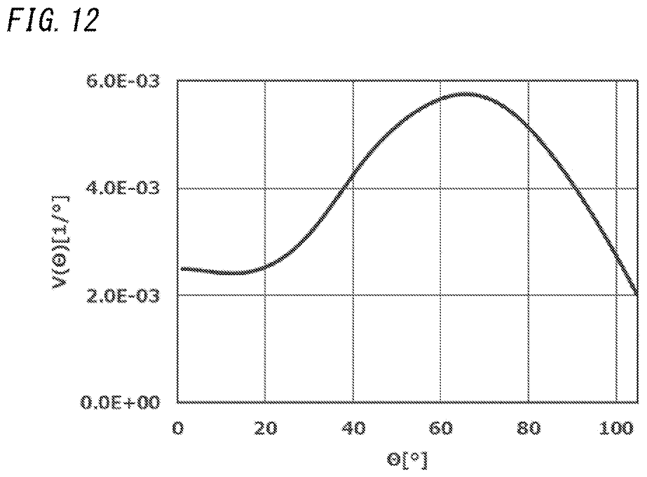

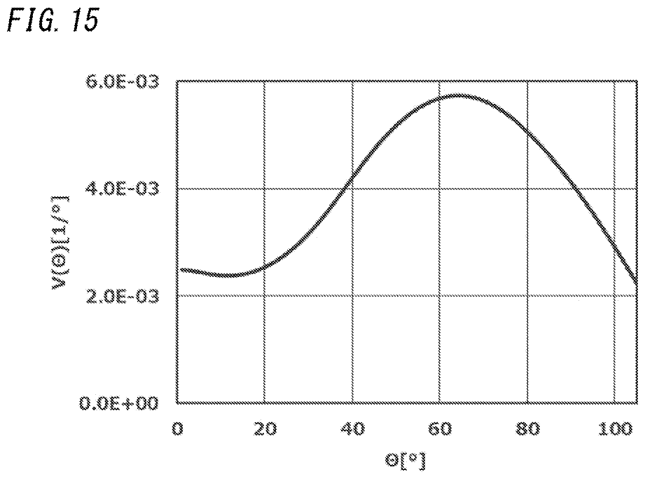

FIGS. 3, 6, 9, 12, and 15 each show the resolution V(θ) at an angle of view θ in the imaging lens systems according to the first to fifth embodiments. V(θ) is expressed by the following equation:

$$V ( θ ) = \frac{Δ h}{Δ θ \times D}$$

where D is the effective diagonal length of the image sensor, Δθ is the difference (increase) in half-angle of view, and Δh is the difference (increase) in image height in response to d-line.

That is to say, this equation normalizes, by the effective diagonal length D of the image sensor, the size (image height) at which a subject image falling within a range that has increased by Δθ from the point corresponding to the angle of view θ is imaged on the image plane S within the range that has increased by Δθ from the image height h. Thus, V(θ) may be regarded as an index to an approximate resolution at which the subject image may be imaged at the angle of view θ.

As is clear from FIGS. 3, 6, 9, 12, and 15, the subject image to be imaged in the toroidal area on the imaging plane (i.e., on the screen) in which the half-angle of view is from around 40 degrees to around 80 degrees may be magnified compared to any other region. Thus, the imaging lens system according to any of the first to fifth embodiments enables increasing the resolution of the subject image to be imaged in the toroidal area on the screen image.

### First Example of Numerical Values

Following is a first exemplary set of numerical values for the imaging lens system corresponding to the first embodiment shown in FIG. 1.

(Surface data)

| | | | | | Effective | Optical |
|---|---|---|---|---|---|---|
| Surface No. | r | d | nd | vd | radius | surface radius |
| Object surface | ∞ | | | | | |
| 1* | 5.05200 | 0.80000 | 1.81000 | 41.0 | 6.096 | 6.196 |
| 2* | 2.43040 | 2.57860 | | | 3.785 | 3.885 |
| 3* | 1.54230 | 0.95240 | 1.53650 | 56.0 | 3.596 | 3.696 |
| 4* | 0.63930 | 2.94820 | | | 1.774 | 1.874 |
| 5* | −11.81290 | 0.94710 | 1.63552 | 24.0 | 1.687 | 1.787 |
| 6* | −2.94370 | 1.17860 | | | 1.601 | 1.787 |
| 7 (aperture) | ∞ | 0.09990 | | | 0.560 | 0.560 |
| 8 | 2.00400 | 0.93470 | 1.55032 | 75.5 | 0.712 | 0.926 |
| 9 | −1.76200 | 0.27470 | | | 0.826 | 0.926 |
| 10* | −1.99390 | 0.36810 | 1.63552 | 24.0 | 0.829 | 0.929 |
| 11* | 1.07430 | 1.35890 | 1.53650 | 56.0 | 1.067 | 1.167 |
| 12* | −1.07120 | 0.52080 | | | 1.269 | 1.369 |
| 13 | ∞ | 0.40000 | 1.51680 | 64.2 | | |
| 14 | ∞ | 0.14000 | | | | |
| Image plane | ∞ | | | | | |

(Aspheric surface data)

1^{st} surface
K = −5.13063E−01, A4 = 5.88495E−05, A6 = −3.57863E−05, A8 = 0.00000E+00
2^{nd} surface
K = −7.68920E−01, A4 = 3.18928E−03, A6 = −1.93319E−04, A8 = 0.00000E+00
3^{rd} surface
K = −5.95541E+00, A4 = −8.75278E−04, A6 = 2.33287E−06, A8 = 0.00000E+00
4^{th} surface
K = −1.82841E+00, A4 = 1.32845E−01, A6 = −5.67688E−03, A8 = 0.00000E+00
5^{th} surface
K = −1.72266E+02, A4 = −2.05610E−02, A6 = 5.09594E−03, A8 = 0.00000E+00
6^{th} surface
K = −2.09475E+00, A4 = −3.85842E−03, A6 = 1.61536E−03, A8 = 0.00000E+00
10^{th} surface
K = −1.26573E+01, A4 = −3.99822E−01, A6 = 1.74430E−01, A8 = 6.74384E−03
11^{th} surface
K = −2.87546E−01, A4 = −4.81125E−01, A6 = 1.25785E−01, A8 = 0.00000E+00
12^{th} surface
K = −2.80472E+00, A4 = −9.34967E−02, A6 = 5.87314E−02, A8 = 0.00000E+00

(Various types of data)

| | |
|---|---|
| Focal length | 0.6293 |
| F number | 2.03039 |
| Angle of view | 105.0000 |
| Image height | 1.8579 |
| Total lens length | 13.5020 |
| BF | 0.00000 |
| Entrance pupil position | 4.0365 |
| Exit pupil position | −30.0778 |
| Anterior principal point | 4.6526 |
| Posterior principal point | 12.8714 |

(Data about single lenses)

| Lens | Start surface | Focal length |
|---|---|---|
| 1 | 1 | −6.6967 |
| 2 | 3 | −3.2217 |
| 3 | 5 | 5.9235 |
| 4 | 8 | 1.8684 |
| 5 | 10 | −1.0496 |
| 6 | 11 | 1.2837 |

### Second Example of Numerical Values

Following is a second exemplary set of numerical values for the imaging lens system corresponding to the second embodiment shown in FIG. 4.

(Surface data)

| | | | | | Effective | Optical |
|---|---|---|---|---|---|---|
| Surface No. | r | d | nd | vd | radius | surface radius |
| Object surface | ∞ | | | | | |
| 1* | 5.11520 | 0.80000 | 1.95150 | 29.8 | 5.980 | 6.080 |
| 2 | 3.31390 | 1.67300 | | | 4.303 | 4.403 |
| 3* | 1.11820 | 0.65320 | 1.53650 | 56.0 | 4.169 | 4.269 |
| 4* | 0.50840 | 4.02910 | | | 2.055 | 2.155 |
| 5 | −27.64760 | 1.00220 | 1.63552 | 24.0 | 1.981 | 2.081 |
| 6* | −3.15160 | 1.18500 | | | 1.909 | 2.081 |
| 7 (aperture) | ∞ | 0.13750 | | | 0.494 | 0.494 |
| 8 | 2.74390 | 0.90960 | 1.61997 | 63.8 | 0.652 | 0.906 |
| 9 | −1.50060 | 0.15490 | | | 0.806 | 0.906 |
| 10* | −1.65930 | 0.35390 | 1.63552 | 24.0 | 0.811 | 0.911 |
| 11* | 1.07460 | 1.41600 | 1.53650 | 56.0 | 1.068 | 1.168 |
| 12* | −0.95410 | 0.50000 | | | 1.282 | 1.382 |
| 13 | ∞ | 0.40000 | 1.51680 | 64.2 | | |
| 14 | ∞ | 0.14000 | | | | |
| Image plane | ∞ | | | | | |

(Aspheric surface data)

1^{st} surface
K = −4.96810E−01, A4 = 2.80535E−05, A6 = −3.56851E−05, A8 = 0.00000E+00
2^{nd} surface
K = −5.43380E−01, A4 = 1.28652E−03, A6 = −1.56006E−04, A8 = 0.00000E+00
3^{rd} surface
K = −4.13720E+00, A4 = −1.98718E−03, A6 = 4.50165E−05, A8 = 0.00000E+00
4^{th} surface
K = −1.57011E+00, A4 = 1.36909E−01, A6 = −1.07858E−02, A8 = 0.00000E+00
5^{th} surface
K = −1.00773E+03, A4 = −7.13327E−03, A6 = 1.48994E−03, A8 = 0.00000E+00
6^{th} surface
K = −2.06322E+00, A4 = 1.73869E−03, A6 = −2.20741E−04, A8 = 0.00000E+00
10^{th} surface
K = −8.24256E+00, A4 = −4.29482E−01, A6 = 2.19165E−01, A8 = 1.23667E−03
11^{th} surface
K = −3.16261E−01, A4 = −4.91320E−01, A6 = 1.32671E−01, A8 = 0.00000E+00
12^{th} surface
K = −2.46684E+00, A4 = −9.10279E−02, A6 = 5.51283E−02, A8 = 0.00000E+00

(Various types of data)

| | |
|---|---|
| Focal length | 0.6302 |
| F number | 2.03415 |
| Angle of view | 105.0000 |
| Image height | 1.8656 |
| Total lens length | 13.3544 |
| BF | 0.00000 |
| Entrance pupil position | 4.4089 |
| Exit pupil position | 46.2241 |
| Anterior principal point | 5.0477 |
| Posterior principal point | 12.7242 |

(Data about single lenses)

| Lens | Start surface | Focal length |
|---|---|---|
| 1 | 1 | −12.6239 |
| 2 | 3 | −2.7759 |
| 3 | 5 | 5.5095 |
| 4 | 8 | 1.7045 |
| 5 | 10 | −0.9771 |
| 6 | 11 | 1.2456 |

### Third Example of Numerical Values

Following is a third exemplary set of numerical values for the imaging lens system corresponding to the third embodiment shown in FIG. 7.

(Surface data)

| | | | | | Effective | Optical |
|---|---|---|---|---|---|---|
| Surface No. | r | d | nd | vd | radius | surface radius |
| Object surface | ∞ | | | | | |
| 1* | 5.08720 | 0.80000 | 1.53650 | 56.0 | 6.665 | 6.765 |
| 2* | 1.69560 | 3.62000 | | | 3.242 | 3.342 |
| 3* | 1.08730 | 0.49480 | 1.53650 | 56.0 | 2.928 | 3.028 |
| 4* | 0.61640 | 2.31450 | | | 1.522 | 1.622 |
| 5* | −12.41490 | 1.04080 | 1.63552 | 24.0 | 1.332 | 1.432 |
| 6* | −3.25820 | 0.61510 | | | 1.127 | 1.432 |
| 7 (aperture) | ∞ | 0.24800 | | | 0.558 | 0.558 |
| 8 | 2.67590 | 0.95270 | 1.72916 | 54.7 | 0.826 | 1.027 |
| 9 | −1.97860 | 0.22250 | | | 0.927 | 1.027 |
| 10* | −2.19040 | 0.30380 | 1.63552 | 24.0 | 0.911 | 1.011 |
| 11* | 1.11430 | 1.46740 | 1.53650 | 56.0 | 1.106 | 1.206 |
| 12* | −1.32400 | 0.50010 | | | 1.280 | 1.380 |
| 13 | ∞ | 0.40000 | 1.51680 | 64.2 | | |
| 14 | ∞ | 0.14000 | | | | |
| Image plane | ∞ | | | | | |

(Aspheric surface data)

1^{st} surface
K = −5.71364E−01, A4 = 2.99920E−04, A6 = −3.06285E−05, A8 = 0.00000E+00
2^{nd} surface
K = −8.73448E−01, A4 = 1.53282E−02, A6 = −7.31724E−04, A8 = 0.00000E+00
3^{rd} surface
K = −6.22710E+00, A4 = −3.16459E−03, A6 = 1.75594E−04, A8 = 0.00000E+00
4^{th} surface
K = −3.03033E+00, A4 = 2.21066E−01, A6 = −1.06522E−02, A8 = 0.00000E+00
5^{th} surface
K = −8.09470E+02, A4 = −2.21471E−02, A6 = 3.26380E−03, A8 = 0.00000E+00
6^{th} surface
K = −6.35662E+00, A4 = −1.33586E−02, A6 = 4.45588E−03, A8 = 0.00000E+00
10^{th} surface
K = −1.64477E+01, A4 = −3.62191E−01, A6 = 2.58031E−01, A8 = −7.81235E−02
11^{th} surface
K = −9.24047E−01, A4 = −2.43353E−01, A6 = 1.15990E−01, A8 = 0.00000E+00
12^{th} surface
K = −2.22331E+00, A4 = −9.35792E−02, A6 = 6.53394E−02, A8 = 0.00000E+00

(Various types of data)

| | |
|---|---|
| Focal length | 0.6301 |
| F number | 2.02017 |
| Angle of view | 105.0000 |
| Image height | 1.8478 |
| Total lens length | 13.1197 |
| BF | 0.00000 |
| Entrance pupil position | 3.6740 |
| Exit pupil position | −12.0513 |
| Anterior principal point | 4.2712 |
| Posterior principal point | 12.5032 |

(Data about single lenses)

| Lens | Start surface | Focal length |
|---|---|---|
| 1 | 1 | −5.1660 |
| 2 | 3 | −4.1902 |
| 3 | 5 | 6.6571 |
| 4 | 8 | 1.7074 |
| 5 | 10 | −1.1221 |
| 6 | 11 | 1.4278 |

### Fourth Example of Numerical Values

Following is a fourth exemplary set of numerical values for the imaging lens system corresponding to the fourth embodiment shown in FIG. 10.

(Surface data)

| | | | | | Effective | Optical |
|---|---|---|---|---|---|---|
| Surface No. | r | d | nd | vd | radius | surface radius |
| Object surface | ∞ | | | | | |
| 1* | 5.06690 | 0.80000 | 1.53650 | 56.0 | 6.530 | 6.630 |
| 2* | 2.57450 | 3.40210 | | | 3.744 | 3.843 |
| 3* | 2.57440 | 0.49860 | 1.53650 | 56.0 | 3.532 | 3.632 |
| 4* | 0.76860 | 2.88590 | | | 1.643 | 1.743 |
| 5* | −18.62470 | 0.59310 | 1.63552 | 24.0 | 1.290 | 1.390 |
| 6* | −2.97440 | 0.68670 | | | 1.280 | 1.390 |
| 7 (aperture) | ∞ | 0.19620 | | | 0.549 | 0.549 |
| 8 | 3.04080 | 0.88310 | 1.72916 | 54.7 | 0.741 | 0.956 |
| 9 | −1.86080 | 0.16840 | | | 0.856 | 0.956 |
| 10* | −2.12200 | 0.43580 | 1.63552 | 24.0 | 0.853 | 0.953 |
| 11* | 1.09160 | 1.54360 | 1.53650 | 56.0 | 1.084 | 1.184 |
| 12* | −1.21230 | 0.50000 | | | 1.292 | 1.392 |
| 13 | ∞ | 0.40000 | 1.51680 | 64.2 | | |
| 14 | ∞ | 0.14000 | | | | |
| Image plane | ∞ | | | | | |

(Aspheric surface data)

1^{st} surface
K = −5.77242E−01, A4 = 2.61896E−04, A6 = −3.05225E−05, A8 = 0.00000E+00
2^{nd} surface
K = −7.49891E−01, A4 = 1.48102E−02, A6 = −7.64610E−04, A8 = 0.00000E+00
3^{rd} surface
K = −1.24305E+01, A4 = −2.12848E−03, A6 = 1.05906E−04, A8 = 0.00000E+00
4^{th} surface
K = −2.12933E+00, A4 = 1.53780E−01, A6 = −4.06788E−03, A8 = 0.00000E+00
5^{th} surface
K = −8.70282E+02, A4 = −4.07825E−02, A6 = −9.21129E−03, A8 = 0.00000E+00
6^{th} surface
K = −5.08161E−02, A4 = −1.20230E−02, A6 = −4.11408E−03, A8 = 0.00000E+00
10^{th} surface
K = −1.81587E+01, A4 = −3.38209E−01, A6 = 2.38420E−01, A8 = −7.18411E−02
11^{th} surface
K = −8.56040E−01, A4 = −2.01888E−01, A6 = 1.12622E−01, A8 = 0.00000E+00
12^{th} surface
K = −3.74074E+00, A4 = −7.04176E−02, A6 = 4.32107E−02, A8 = 0.00000E+00

(Various types of data)

| | |
|---|---|
| Focal length | 0.6299 |
| F number | 1.99217 |
| Angle of view | 105.0000 |
| Image height | 1.8501 |
| Total lens length | 13.1335 |
| BF | 0.00000 |
| Entrance pupil position | 4.5002 |
| Exit pupil position | −20.8360 |
| Anterior principal point | 5.1111 |
| Posterior principal point | 12.5178 |

(Data about single lenses)

| Lens | Start surface | Focal length |
|---|---|---|
| 1 | 1 | −10.9868 |
| 2 | 3 | −2.2603 |
| 3 | 5 | 5.4889 |
| 4 | 8 | 1.7133 |
| 5 | 10 | −1.0774 |
| 6 | 11 | 1.3976 |

### Fifth Example of Numerical Values

Following is a fifth exemplary set of numerical values for the imaging lens system corresponding to the fifth embodiment shown in FIG. 13.

(Surface data)

| | | | | | Effective | Optical |
|---|---|---|---|---|---|---|
| Surface No. | r | d | nd | vd | radius | surface radius |
| Object surface | ∞ | | | | | |
| 1* | 4.67380 | 0.80000 | 1.69350 | 53.2 | 5.896 | 5.996 |
| 2* | 2.49720 | 2.82040 | | | 3.541 | 3.641 |
| 3* | 1.49070 | 0.49910 | 1.53650 | 56.0 | 3.327 | 3.427 |
| 4* | 0.64480 | 2.56330 | | | 1.626 | 1.726 |
| 5* | −5.23990 | 0.57380 | 1.65670 | 21.2 | 1.316 | 1.416 |
| 6* | −2.70450 | 0.38990 | | | 1.181 | 1.416 |
| 7* | −8.23450 | 0.53880 | 1.65670 | 21.2 | 0.891 | 0.991 |
| 8* | −3.94540 | 0.30450 | | | 0.771 | 0.991 |
| 9 (aperture) | ∞ | −0.02870 | | | 0.508 | 0.508 |
| 10 | 3.63190 | 0.61010 | 1.72916 | 54.7 | 0.513 | 0.811 |
| 11 | −1.36500 | 0.29710 | 1.84666 | 23.8 | 0.624 | 0.811 |
| 12 | −1.91740 | 0.33740 | | | 0.711 | 0.811 |
| 13* | −1.74750 | 0.30000 | 1.65670 | 21.2 | 0.758 | 0.858 |
| 14* | 1.36530 | 1.38090 | 1.53650 | 56.0 | 1.009 | 1.109 |
| 15* | −0.90760 | 0.53870 | | | 1.245 | 1.345 |
| 16 | ∞ | 0.40000 | 1.51680 | 64.2 | | |
| 17 | ∞ | 0.14000 | | | | |
| Image plane | ∞ | | | | | |

(Aspheric surface data)

1^{st} surface
K = −6.24371E−01, A4 = 3.19590E−04, A6 = −3.85171E−05, A8 = 0.00000E+00
2^{nd} surface
K = −6.88678E−01, A4 = 1.19292E−02, A6 = −7.14523E−04, A8 = 0.00000E+00
3^{rd} surface
K = −8.72204E+00, A4 = −3.55742E−03, A6 = 1.97905E−04, A8 = 0.00000E+00
4^{th} surface
K = −2.24695E+00, A4 = 1.34233E−01, A6 = −1.86196E−03, A8 = 0.00000E+00
5^{th} surface
K = −1.65071E+01, A4 = 2.12878E−03, A6 = −3.67537E−04, A8 = 0.00000E+00
6^{th} surface
K = −9.21598E+00, A4 = 6.98584E−03, A6 = 6.87350E−03, A8 = 0.00000E+00
7^{th} surface
K = −6.72674E+01, A4 = 3.36193E−03, A6 = −2.64173E−02, A8 = 0.00000E+00
8^{th} surface
K = −8.53351E+00, A4 = −3.80688E−02, A6 = 6.25168E−03, A8 = 0.00000E+00
13^{th} surface
K = −2.12900E+00, A4 = −2.11083E−01, A6 = 4.60836E−02, A8 = 5.38490E−02
14^{th} surface
K = −1.57475E+00, A4 = −2.27786E−01, A6 = 9.55049E−02, A8 = 0.00000E+00
15^{th} surface
K = −2.70614E+00, A4 = −1.04633E−01, A6 = 5.67384E−02, A8 = 0.00000E+00

(Various types of data)

| | |
|---|---|
| Focal length | 0.6304 |
| F number | 2.03361 |
| Angle of view | 105.0000 |
| Image height | 1.8560 |
| Total lens length | 12.4653 |
| BF | 0.00000 |
| Entrance pupil position | 4.1793 |
| Exit pupil position | 141.2567 |
| Anterior principal point | 4.8125 |
| Posterior principal point | 11.8425 |

(Data about single lenses)

| Lens | Start surface | Focal length |
|---|---|---|
| 1 | 1 | −9.1021 |
| 2 | 3 | −2.6676 |
| 3 | 5 | 7.8106 |
| 4 | 7 | 10.9873 |
| 5 | 10 | 1.4345 |
| 6 | 11 | −7.4276 |
| 7 | 13 | −1.1242 |
| 8 | 14 | 1.2898 |

(Values Corresponding to Inequalities)

Values, corresponding to the Inequalities (1) to (8), of the respective examples of numerical values are shown in the following table:

| | | 1^{st} example of | 2^{nd} example of | 3^{rd} example of | 4^{th} example of | 5^{th} example of |
|---|---|---|---|---|---|---|
| | | numerical values | numerical values | numerical values | numerical values | numerical values |
| | f | 0.629 | 0.630 | 0.630 | 0.630 | 0.630 |
| | f1 | −20.045 | 11.515 | −8.261 | −21.730 | 12.203 |
| | f2 | 2.207 | 1.956 | 2.179 | 2.157 | 2.023 |
| | R2 | 2.430 | 3.314 | 1.696 | 2.575 | 2.497 |
| | R3 | 1.542 | 1.118 | 1.087 | 2.574 | 1.491 |
| | R4 | 0.639 | 0.508 | 0.616 | 0.769 | 0.645 |
| | T | 13.502 | 13.354 | 13.120 | 13.134 | 12.465 |
| | T2 | 2.579 | 1.673 | 3.620 | 3.402 | 2.820 |
| | T4 | 2.948 | 4.029 | 2.315 | 2.886 | 2.563 |
| Inequality (1) | T2/R2 | 1.061 | 0.505 | 2.135 | 1.321 | 1.129 |
| Inequality (2) | T4/R4 | 4.612 | 7.925 | 3.755 | 3.755 | 3.975 |
| Inequality (3) | (R3 + R2)/ | −4.473 | −2.019 | −4.575 | −5.149E+04 | −3.962 |
| | (R3 − R2) | | | | | |
| Inequality (4) | \|f/f1\| | 0.031 | 0.055 | 0.076 | 0.029 | 0.052 |
| Inequality (5) | f/f2 | 0.285 | 0.322 | 0.289 | 0.292 | 0.312 |
| Inequality (6) | ν1 | 40.95 | 29.83 | 55.98 | 55.98 | 53.20 |
| Inequality (7) | ν2p1 | 75.50 | 63.88 | 54.67 | 54.67 | 54.67 |
| | ν2p2 | 55.98 | 55.98 | 55.98 | 55.98 | 55.98 |
| Inequality (8) | T/f | 21.455 | 21.192 | 20.821 | 20.850 | 19.774 |

The first, second, third, fourth, fifth and sixth embodiments have been described as exemplary embodiments of the present disclosure. The detailed description and accompanying drawings have been provided solely for the purpose of presenting such exemplary embodiments.

It should be noted, however, that the constituent elements mentioned in the detailed description and illustrated on the accompany drawings include not only essential constituent elements that have to be used to overcome the problem for the present disclosure but also other optional and inessential constituent elements that may be, but do not have to be, used to overcome the problem and that are mentioned or illustrated just for the purpose of providing some examples of the present disclosure. Therefore, those inessential constituent elements should not be construed as essential ones, simply because such inessential constituent elements are mentioned in the detailed description or illustrated on the drawings.

Note that the embodiments described above are only examples of the present disclosure and should not be construed as limiting. Rather, each of those embodiments may be readily modified, replaced, combined with other embodiments, or partially omitted in various manners without departing from the scope of the appended claims and their equivalents.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The present disclosure is applicable to imaging lens systems for use in, for example, onboard cameras, surveillance cameras, and Web cameras. Among other things, the present disclosure is particularly effectively applicable as an imaging lens system to cameras such as onboard cameras that are required to have high image quality.

1. An imaging lens system consisting of:
a first lens group;
an aperture stop; and
a second lens group having positive power,
the first lens group, the aperture stop, and the second lens group being arranged in this order such that the first lens group is located closer to an object than the aperture stop or the second lens group is and that the second lens group is located closer to an image than the first lens group or the aperture stop is,
the first lens group including:
a first lens having negative power;
a second lens having negative power; and
a sub-lens group having positive power,
the first lens, the second lens, and the sub-lens group being arranged in this order such that the first lens is located closer to the object than the second lens or the sub-lens group is and that the sub-lens group is located closer to the image than the first lens or the second lens is,
the first lens being a negative meniscus lens having a surface convex toward the object,
the second lens being a negative meniscus lens having a surface convex toward the object,
the imaging lens system satisfying the following inequalities (1) and (2):
0.35<T2/R2<4.0 (1)
3.0<T4/R4<10.0 (2)
where R2 is a radius of curvature of an image-side surface of the first lens, R4 is a radius of curvature of an image-side surface of the second lens, T2 is a distance on an optical axis between the image-side surface of the first lens and an object-side surface of the second lens, and T4 is a distance on the optical axis between the image-side surface of the second lens and an object-side surface of a lens belonging to the sub-lens group and located closer to the object than any other lens belonging to the sub-lens group.

2. The imaging lens system of claim 1, wherein
the imaging lens system satisfies the following inequality (3):
(R3+R2)/(R3−R2)<−1.0 (3)
where R2 is the radius of curvature of the image-side surface of the first lens and R3 is a radius of curvature of the object-side surface of the second lens.

3. The imaging lens system of claim 1, wherein
the imaging lens system satisfies the following inequality (4):

|f/f1|<0.2 (4)
where f is a focal length of the imaging lens system in response to a d-line and f1 is a focal length of the first lens group in response to the d-line.

4. The imaging lens system of claim 1, wherein
the imaging lens system satisfies the following inequality (5):
0.2<f/f2<0.4 (5)
where f is a focal length of the imaging lens system in response to a d-line and f2 is a focal length of the second lens group in response to the d-line.

5. The imaging lens system of claim 1, wherein
the imaging lens system satisfies the following inequality (6):
υ1>25 (6)
where υ1 is an Abbe number of the first lens in response to a d-line.

6. The imaging lens system of claim 1, wherein
the second lens group includes first through N^{th} lenses, each having positive power, where N is an integer equal to or greater than one,
each of one or more integers i that meet 1≤i≤N satisfies the following inequality (7):
υ2pi>50 (7)
where υ2pi is an Abbe number of an i^{th} lens belonging to the second lens group and having positive power in response to a d-line.

7. The imaging lens system of claim 1, wherein
the imaging lens system satisfies the following inequality (8):
15<T/f<26 (8)
where f is a focal length of the imaging lens system in response to a d-line and T is a total lens length of the imaging lens system,
the total lens length being a distance between an object-side surface of a lens belonging to a plurality of lenses included in the imaging lens system and located closer to the object than any other one of the plurality of lenses and an image plane.

8. The imaging lens system of claim 1, wherein
at least one of an object-side convex surface of the first lens or an image-side concave surface of the first lens is an aspheric surface, of which an optical surface radius is greater than an absolute value of a paraxial radius of curvature, the object-side convex surface being the surface convex toward the object.

9. The imaging lens system of claim 1, wherein
an image-side convex surface of a lens, belonging to a plurality of lenses included in the imaging lens system and located closer to the image than any other one of the plurality of lenses, has an aspheric surface having positive power that decreases as a distance from the optical axis increases, the image-side convex surface being convex toward the image.

10. A camera comprising:
the imaging lens system of claim 1 configured to form an optical image of the object; and
an image sensor configured to transform the optical image formed by the imaging lens system into an electrical image signal.
